(19) United States
(12) Patent Application Publication
(10) Pub. No.: US 2007/0001674 A1
(43) Pub. Date: Jan. 4, 2007

(54) Object motion correction during MR imaging

(76) Inventor: David Embrey Purdy, Pearland, TX (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/170,334

(22) Filed: Jun. 29, 2005

(51) Int. Cl. G01V 3/00

(52) U.S. Cl. 324/309

(57) ABSTRACT

A method and apparatus for magnetic resonance (MR) imaging of a moving object, wherein motion data are acquired about movement of the object in multiple dimensions during a “pre-scan” of the object, prior to the acquisition of image data during a succeeding “imaging scan” of the object. Because motions of the object in one dimension are to some degree correlated with object motions in other dimensions, in accordance with the invention, the pre-scan multi-dimensional motion data are used to develop algorithms that relate the motion data of the object in a first dimension to the motion data of the object in a second or third dimension. Thus, during the subsequent acquisition of the image data during the imaging scan, it is only necessary to measure the object motion in one dimension, which measured data are then used in order to estimate object movement in the other one or two dimensions using the algorithms developed from the pre-scan motion data. The measured and/or estimated motion data are then used to adjust the image data or image plane, so as to reduce (or even prevent) image distortion due to object motion.

### CROSS-REFERENCE TO RELATED APPLICATIONS

None.

### BACKGROUND OF THE INVENTION

1. Field of the Invention

The present invention relates to magnetic resonance (MR) imaging, and more particularly relates to a method and apparatus for correcting the effects of object motion during MR imaging.

2. Description of the Related Art

Magnetic Resonance (MR) images can be degraded by object motion during the imaging scan. This problem is particularly evident when acquiring MR images of the abdomen of a living patient, if the patient breaths during the imaging scan. Several methods exist for monitoring patient motion, and then correcting the MR image data. Methods exist for the retrospective correction of in-plane shifts of the tissue, and also for prospective correction of the position of the scan plane, thus tracking the tissue motion.

One method of monitoring the patient motion uses a so-called “navigator acquisition.” In this method, a one-dimensional image or profile of the tissue is rapidly acquired using a single radiofrequency (RF) excitation simultaneous with the application of a magnetic field (“slice selection”) gradient in one direction, followed by additional gradient pulses, and signal acquisition of the gradient echo during the application of one of these additional gradient pulses (the “readout gradient”). The image profile direction is the direction of the readout gradient, this direction usually being perpendicular to the slice selection direction. Using image profiles reconstructed from navigator acquisitions of this type (hereby called “navigator image profiles”), one can determine tissue position in a given dimension, for example, the superior-inferior position of the diaphragm of the patient. The time course of the diaphragm movement in the measured dimension can be used to adjust the superior-inferior position of the next (or a following) slice-selective RF pulse used to acquire one of the several Fourier lines required for the normal transverse imaging scan.

In this manner, the same slab (“slice”) of tissue, though moving, is excited for each of the data acquisitions needed for the MR image, thus reducing the image blur. Since navigator acquisitions are relatively short, they are typically interleaved with the excitations required for each line of the imaging scan; one navigator acquisition precedes the acquisition of each Fourier line of the imaging scan. This technique allows the spatial position of each of the slice-selective RF pulses used for imaging to be adjusted so as to minimize image distortion due to patient motion. A limitation of this method is that the slice position can only be corrected in the direction for which the navigator positional information is available.

By known methods, the time course of the tissue motion can also be used to adjust the phase of each data point of the imaging scan, and thus correct for in-plane motions of the tissue. A limitation of this method is that in-plane motion can only be corrected in the direction for which navigator positional information is available.

It is possible to precede each of the slice-selective RF excitations used to acquire the image with not one, but two or even three navigator acquisitions. Each navigator acquisition comprises an RF pulse and associated simultaneous gradient pulse, additional gradient pulses, and an acquisition period. The direction of the readout gradient pulses of each of these two or three navigator acquisitions is orthogonal to that of the other navigator acquisitions. The pattern is:
x-navigator˜y-navigator˜z-navigator˜Fourier line #1˜x-navigator˜y-navigator˜z-navigator˜Fourier line #2, etc.

This imaging scan pattern demonstrates the interleaving of navigator acquisition in three dimensions with the ordinary Fourier line acquisitions. The x, y, and z notations refer to the directions of the readout gradients of the navigator acquisitions.

Thus, the positional data needed to correct the imaging data in two or three orthogonal directions is obtained. However, these additional data acquisitions require a significant amount of additional time, and thus slow down the overall image scan time.

Even furthermore, it is believed that computer limitations may make it impractical for the positional information of the navigator scan to be analyzed quickly enough to correct the slice position of the immediately following slice-selective imaging RF pulse. One may attempt to overcome this limitation by applying the navigator-based prospective correction of the slice position to the slice-selective pulse of the next following Fourier line, rather than the Fourier line that immediately follows the navigator scan. For example, in the above example, the first set of navigators could be applied to the selective pulse of Fourier line #2, or even Fourier line #3, in an effort to overcome the above-noted time limitations, but this may not result in sufficient nor satisfactory correction.

### SUMMARY OF THE INVENTION

A method and apparatus for magnetic resonance (MR) imaging of a moving object, typically a living patent, wherein motion data are acquired about movement of the patient in multiple dimensions during a “pre-scan” of the patient, prior to the acquisition of image data during a succeeding “imaging scan” of the patient. The pre-scan multi-dimensional motion data are used to develop algorithms that relate the motion data of the patient in a first dimension to the motion data of the patient in a second or third dimension. During the subsequent acquisition of the image data during an imaging scan, it is only necessary to measure the patient motion in one dimension, which measured data are then used in order to estimate patient movement in the other one or two dimensions using the algorithms developed from the pre-scan motion data. The estimated motion data is then used to adjust at least one of the in-plane image data or image plane position, so as to reduce image distortion due to patient motion.

### BRIEF DESCRIPTIONS OF THE DRAWINGS

In order to better understand the invention, the accompanying illustrative and non-limiting drawing, which is incorporated herein and constitute part of this specification, illustrate embodiments and details of the invention, and, together with the general description given above and the detailed description given below, serve to further explain the features of the invention.

FIG. 1 illustrates a flow chart useful for understanding the method and apparatus of the invention.

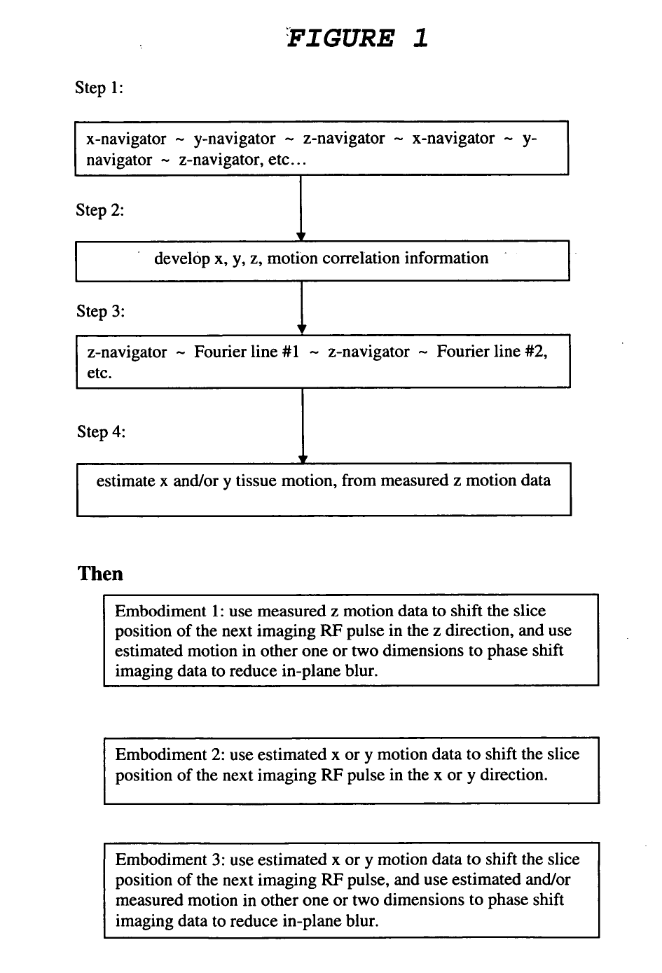

FIG. 2 shows a block diagram illustrating the operation of an MR imaging system 10 which may be used for practicing the method and apparatus of the invention.

### DETAILED DESCRIPTION OF THE PREFERRED EMBODIMENTS

The method and apparatus of the present invention is practiced on a conventional, and thus well known, MR imaging apparatus, thus neither a detailed description of the MR imaging apparatus, nor details of the conventional pulse sequences needed for operating the MR imager is provided herein.

In accordance with the principles of the present invention, prior to the start of the image acquisition pulse sequence (the so-called “imaging scan” of a patient), two or three navigator RF pulses are applied to the patient with the appropriate gradient pulses to acquire one-dimensional tissue profiles of the patient in two, or preferably three, orthogonal spatial directions. These data are acquired repetitively in a pre-scan having a time period that preferably encompasses several cycles of the expected patient movement, for example, several cycles of breathing. This pre-scan is completed before the acquisition of any of the ordinary imaging data.
x-navigator˜y-navigator˜z-navigator˜x-navigator˜y-navigator ˜z-navigator, etc.
where x, y, and z refer to the directions of the readout gradients of the navigator acquisitions.

In accordance with the invention, the assumption is made that the tissue motion of the patient in one direction correlates well with the tissue motion of the patient in the other one or two orthogonal directions. Thus, the one-dimensional information obtained for each direction are compared with one another using, for example standard statistical methods, and correlations between the data are developed. For example, it may be found that during breathing, the patient's chest wall moves anteriorly by 0.5 cm when the diaphragm moves superiorly by 1 cm. While the patient's breathing rate or depth may be irregular, the movement of the internal organs in the anterior-posterior direction and the left-right direction will be relatively well-correlated to the movement in the superior-inferior direction. Algorithms that describe the correlation of the position data measured in one dimension to the position data measured in the other one or two orthogonal dimensions are developed. As used herein, the term algorithm is meant to include not only formulistic correlations, such as Y=mX+b, but also tabular correlations, such as shown in the below table:

| | Chest |
|---|---|
| Diaphragm wall in coronal image | wall in traverse image |
| 0 mm (defined for 1^{st} time point) | 104 mm from isocenter |
| 3 | 110 |
| 4 | 111 |
| 8 | 125 |
| 12 | 134 |
| 15 | 135 |
| 16 | 136 |
| 17 | 137 |
| 17 | 137 |

As noted above, in accordance with the invention, this correlation information is determined during the pre-scan described above. After this, as shown by Step 2 of the Sole Figure, a normal imaging scan using only a one-dimensional navigator acquisition is performed. Thus, between each RF excitation used for normal imaging, an RF pulse, gradient, and acquisition period are interleaved to obtain navigator information in only one dimension, using a technique such as known in the prior art.

Accordingly, the imaging scan pattern of the invention is, as also shown by Step 2 in the sole Figure, assuming a navigator in the z direction:
z-navigator˜Fourier line #1˜z-navigator˜Fourier line #2, etc.

Then, as shown by Step 3 in the Sole Figure, the positional information from this navigator profile is used with the correlation data from the pre-scan to estimate the tissue motion in the other one or two dimensions. This computation could be accomplished using algorithms as simple as multiplication, table interpolation, or some other technique, such as those well known by those skilled in MR image processing technology.

In one embodiment of the invention, the one-dimensional positional information acquired by interleaved navigators during the imaging scan is combined with the prescan correlative information to predict the tissue motion in one or two dimensions that are orthognal to the acquired one dimension. Then, the one dimensional positional information acquired in a particular direction during the imaging scan is used to prospectively shift the slice position of the next imaging RF pulse (the shift direction being in the same particular direction), and the estimated tissue movement in the other two or three dimensions is used to phase shift in-plane imaging data points to reduce in-plane blur.

In a second embodiment of the invention, the one-dimensional positional information acquired by interleaved navigators during the imaging scan is combined with the prescan correlative information to predict the tissue motion in one or two dimensions that are orthogonal to the acquired one dimension, as in the above described first embodiment. Then, one-dimensional positional information that is estimated from the positional information acquired during the imaging scan, is used to prospectively shift the slice position of the next imaging RF pulse. This technique may be advantageous when, for example, a coronal slice is acquired, and anterior-posterior adjustment of the slice position is desired, but the most desirable direction for an easily-interpreted navigator is superior-inferior.

In a third embodiment of the invention, the one-dimensional positional information acquired by interleaved navigators during the imaging scan is combined with the prescan correlative information to predict the tissue motion in one or two dimensions that are orthogonal to the acquired one dimension, as in the above described first and second embodiments. Then, one dimensional positional information that is estimated from the positional information acquired during the imaging scan, is used to prospectively shift the slice position of the next imaging RF pulse, and the measured or estimated tissue movement in the other one or two dimensions is used to phase shift imaging data points to reduce in-plane blur.

In a fourth embodiment, the steps of the first, second or third embodiment are followed, but the slice position corrections are applied not to the immediately following imaging RF slice selection pulse, but rather to the imaging RF slice selection pulse following said pulse, or to an even later RF slice selection pulse, this delay being made to allow extra computer processing time.

In a fifth embodiment, the RF slice selection pulse for the navigator follows the RF slice selection pulse for imaging.

In a sixth embodiment, a single RF slice selection pulse is used to acquire a single Fourier line of the imaging scan, after which the effects of the associated phase encoding and readout gradients are nullified, and an additional echo signal is formed using a readout gradient to create a navigator acquisition. The navigator is acquired without the need of a separate RF pulse. In this embodiment, the direction of the navigator slice selection and the imaging slice selection are the same, and the measured position information can be used as described in the above examples to correct the slice position and in-plane blur.

In a seventh embodiment, each Fourier line of the imaging scan is acquired with a pulse sequence that requires more than one RF pulse, such as a spin echo sequence.

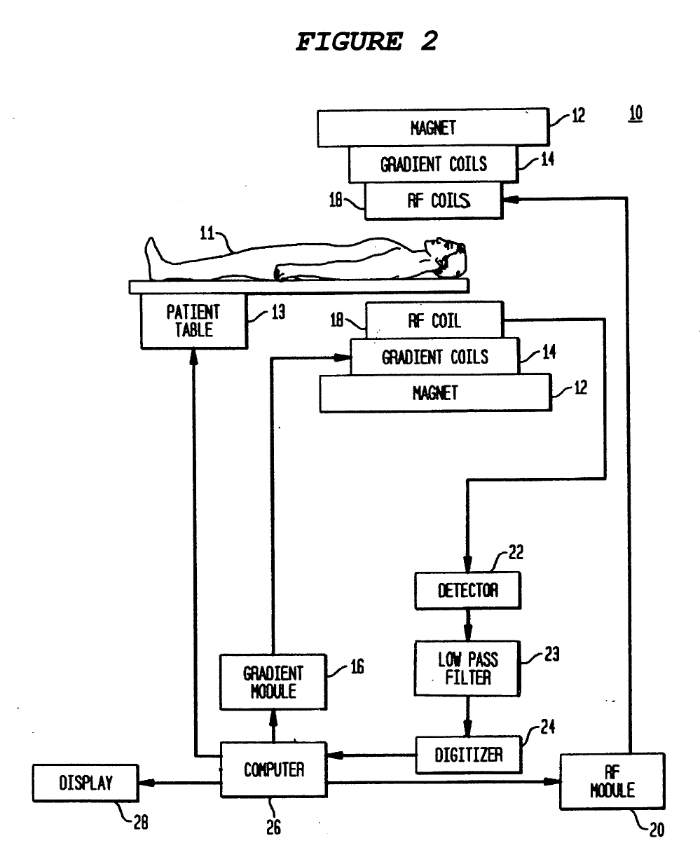

FIG. 2 shows a block diagram illustrating the construction and operation of one embodiment of an exemplary MR imaging system 10 which may be used in connection with the method and apparatus of the invention. Since such imagers are well known, and therefore only a brief overview description is provided herein. A magnet 12 is provided for creating a static/base magnetic field in an object to be imaged, such as the body 11 of a living patient, positioned on a table 13. Within the magnet system are gradient coils 14 for producing position dependent magnetic field gradients superimposed on the static magnetic field. Gradient coils 14, in response to gradient signals supplied thereto by a gradient module 16, produce the position dependent magnetic field gradients in three orthogonal directions. Within the gradient coils is an RF coil 18. An RF module 20 provides RF pulse signals to the RF coil 18, which in response produces magnetic field pulses which rotate the spins of the protons in the imaged body 11 by ninety degrees or by one hundred and eighty degrees for so-called “spin echo” imaging, or by angles less than or equal to 90 degrees for so-called “gradient echo” imaging. In response to the applied RF pulse signals, the RF coil 18 receives MR signals, i.e., signals from the excited protons within the body as they return to an equilibrium position established by the static and gradient magnetic fields, which MR signals are detected by a detector 22 (comprising a preamplifier and amplifier), the MR signals are then filtered by an analog low-pass filter 23 (the pass band of which is controlled directly or indirectly by the pulse sequence and computer 26), converted into digital signals by a digitizer 24 and applied to the MR system computer 26. Alternatively, the function of analog low-pass filter 23 may be carried out by subjecting the digital signals supplied from digitizer 24 to digital filtration algorithms in computer 26.

In a manner well known to those of ordinary skill in this technology, the gradient magnetic fields are utilized in combination with the RF pulses to encode spatial information into the MR signals emanating from a slice of the body being imaged. Computer 26, using algorithms that are supplied with the details of the pulse sequence, such as the strengths of the applied gradient magnetic fields, adjusts other parameters of the MR imaging system, so as to process the detected MR signals in a coordinated manner to generate high quality images of a selected slab (or slabs) of the body, which images are then shown on a display 28.

For the purposes of promoting an understanding of the principles of the invention, reference has been made to the preferred embodiments illustrated by the drawing, and specific language has been used to describe these embodiments. However, this specific language is not intended to limit the scope of the invention, and the invention should be construed to encompass all embodiments that would normally occur to one of ordinary skill in the art. For example, the particular implementations shown and described herein are illustrative examples of the invention and are not intended to otherwise limit the scope of the invention in any way. For the sake of brevity, conventional electronics, control systems, and other functional aspects of the systems (and components of the individual operating components of the systems) may not be described in detail. Furthermore, the connecting lines, or connectors shown in the figure are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention. For example, the pre-scan pattern shown in Step 1 of the Sole Figure illustrates a three-dimensional embodiment of the invention, however, in an alternative embodiment, the pre-scan pattern may be in only two-dimensions.

Accordingly, it is intended that the present invention not be limited to the described embodiments, but that it has the full scope defined by the above language and the following claims, as well as equivalents thereof.

The following claims provide further details concerning the elements, actions, and/or steps that are contemplated as falling within the scope of the methods and apparatus of the present invention.

What is claimed is:

1. A method of operating an MR device to image an object, comprising the following steps in the presented order:
applying a pre-scan navigator pulse sequence to the object so as to acquire motion data about movement of the object in multiple dimensions during a pre-scan time interval, which pre-scan time interval is prior to the acquisition of image data during a succeeding imaging scan of the object;
using the multiple dimension motion data acquired during the pre-scan to develop algorithms that correlate the motion data of the object in a first dimension to the motion data of the object in a second or third dimension;
applying an MR imaging pulse sequence, including RF slice selection pulses and readout gradient pulses, to the object during a subsequent imaging scan so as to cause an interleaving of the acquisition of object motion data in one dimension with the acquisition of image planes of image data;
estimating object movement in another one or two dimensions using the acquired motion data in the one dimension and the algorithms developed from the pre-scan motion data; and
adjusting at least one of in-plane image data or image plane position during the imaging scan using at least one of the measured or estimated -movement data, so as to minimize image distortion due to object motion.

2. The method of claim 1, wherein said step of applying a pre-scan navigator pulse sequence applies a pre-scan pulse sequence that includes navigator pulses in three dimensions.

3. The method of claim 1, wherein said step of applying a pre-scan navigator pulse sequence applies a pre-scan pulse sequence that includes navigator pulses in only two dimensions

4. The method of claim 1, wherein said step of applying an imaging pulse sequence applies an imaging pulse sequence that includes navigator pulses in only one dimension.

5. The method of claim 2, wherein said step of applying an imaging pulse sequence applies an imaging pulse sequence that includes navigator pulses in only one dimension.

6. The method of claim 1, wherein said adjusting step comprises:
using the one dimensional positional information acquired during the imaging scan to prospectively shift the slice position of a next imaging scan RF pulse to reduce image distortion, and
using estimated tissue movement in the other two or three dimensions to phase shift imaging data points to reduce in-plane blur.

7. The method of claim 1, wherein said adjusting step comprises:
using the one dimensional positional information that is estimated from the positional information acquired during the imaging scan to prospectively shift the slice position of a next imaging scan RF pulse

8. The method of claim 7, wherein said adjusting step comprises:
using the measured or estimated tissue movement in the other one or two dimensions to phase shift imaging data points to reduce in-plane blur.

9. The method of claim 6, wherein the slice position corrections are applied to an imaging RF slice selection pulse which follows said next RF slice selection pulse.

10. The method of claim 7, wherein the slice position corrections are applied to an imaging scan RF slice selection pulse which follows said next RF slice selection pulse.

11. The method of claim 8, wherein the slice position corrections are applied to an imaging scan RF slice selection pulse which follows said next RF slice selection pulse.

12. The method of claim 1, wherein the imaging scan pulse sequence includes a navigator RF slice selection pulse which precedes the RF slice selection pulse used for imaging.

13. The method of claim 1, wherein the imaging scan pulse sequence includes a navigator RF slice selection pulse which follows the RF slice selection pulse used in for imaging.

14. The method of claim 1, wherein a single RF slice selection pulse in a given direction is used to acquire a single Fourier line during the imaging scan, and including the following steps:
nullifying the effects of phase encoding and readout gradients associated with the single RF slice selection pulse,
forming an additional echo signal using a readout gradient to create a navigator acquisition without the need of a separate RF pulse, and
using the estimated position information to minimize image distortion.

15. The method of claim 1, wherein the imaging scan acquires a plurality of Fourier lines, each line being acquired with a pulse sequence that requires more than one RF pulse, such as when the imaging scan is acquired using a spin echo sequence.

16. An MR device for forming an image of an object, comprising:
a computer controlled pulse generating means and pulse radiating means for applying a pre-scan navigator pulse sequence to the object during a pre-scan time interval,
signal receiving means for receiving signals from said object in response to said applied pre-scan navigator pulse sequence,
computer controlled signal processing means for processing said received signals so as to acquire motion data about movement of the object in multiple dimensions during said pre-scan time interval, which pre-scan time interval is prior to the acquisition of image data during a succeeding imaging scan of the object;
said computer controlled signal processing means being responsive to the multiple dimension motion data acquired during the pre-scan to develop algorithms that correlate the motion data of the object in a first dimension to the motion data of the object in a second or third dimension;
said a computer controlled pulse generating means and pulse radiating applying an MR pulse sequence including an RF slice selection pulse to the object during a subsequent imaging scan so as to cause an interleaving of the acquisition of object motion data in one dimension with the acquisition of image planes of image data; and,
said computer controlled signal processing means:
developing estimated object movement data in another one or two dimensions using the acquired motion data in the one dimension and the algorithms developed from the pre-scan motion data; and
adjusting at least one of in-plane image data or image plane position during the imaging scan using at least one of the measured or estimated movement data, so as to minimize image distortion due to object motion.

17. The apparatus of claim 16, wherein said computer controlled pulse generating means and pulse radiating means apply to the object a pre-scan navigator pulse sequence that includes navigator pulses in three dimensions.

18. The apparatus of claim 16, wherein said computer controlled pulse generating means and pulse radiating means apply to the object a pre-scan navigator pulse sequence that includes navigator pulses in only two dimensions.

19. The apparatus of claim 16, wherein said computer controlled signal processing means:
uses the one dimensional positional information acquired during the imaging scan to prospectively shift the slice position of a following imaging RF pulse to reduce image distortion, and
uses the estimated tissue movement in the other two or three dimensions to phase shift imaging data points to reduce in-plane blur.

20. The apparatus of claim 16, wherein said computer controlled signal processing means uses the one dimensional positional information that is estimated from the positional information acquired during the imaging scan to prospectively shift the slice position of a following imaging scan RF pulse.
